(19) United States
(12) Patent Application Publication
(10) Pub. No.: US 2007/0186767 A1
(43) Pub. Date: Aug. 16, 2007

(54) Device for detecting the position of a hydraulic piston-cylinder system

(75) Inventors: Martin Staudinger, Ettlingen (DE); Felix Dreher, Buehl (DE)

Correspondence Address: Robert P. Simpson, Esq.;Simpson & Simpson, PLLC, 5555 Main Street, Williamsville, NY, 14221-5406, US

(73) Assignee: LuK Lamellen und Kupplungsbau Beteiligungs KG, Buehl (DE)

(21) Appl. No.: 11/703,419

(22) Filed: Feb. 7, 2007

(30) Foreign Application Priority Data
Feb. 11, 2006 (DE) 10 2006 006 354.6

(51) Int. Cl. F01B 31/12; F01B 25/26; F16J 10/00; G01B 7/30

(52) U.S. Cl. 92/5 R; 91/1; 92/169.1; 324/207.2

(57) ABSTRACT

A device for detecting the position of a hydraulic piston-cylinder system, where the hydraulic piston-cylinder system is connected to a position-detecting means which comprises a magnet and a Hall sensor and the connection between the hydraulic piston-cylinder system and the position-detecting means comprises a lever.

### CROSS-REFERENCE TO RELATED APPLICATION

This patent claims priority of German patent application 10 2006 006 354.6, filed Feb. 11, 2006, which application is incorporated herein by reference.

### FIELD OF THE INVENTION

The present invention relates to a device for detecting the position of a hydraulic piston-cylinder system, where the hydraulic piston-cylinder system is connected to a position-detecting means, which comprises a magnet and a Hall sensor.

### BACKGROUND OF THE INVENTION

Such devices are generally known. Thus, in the state of the art the position of a piston relative to a cylinder is detected by a Hall sensor disposed in the vicinity of the piston. This Hall sensor measures the magnetic field of a magnet fastened to the piston. Since the field of the magnet at the location of the Hall sensor decreases with the distance of the Hall sensor from the magnet, the position of the magnet relative to the Hall sensor, and thus the distance of the piston from the Hall sensor, can be calculated from the value of the magnetic field at the location of the Hall sensor. Then if the Hall sensor is disposed so as to be fixed relative to the cylinder, the distance of the piston from the cylinder, and thus the position of the piston-cylinder system, can be determined from the distance between the piston and the Hall sensor.

These devices are indeed economical and can be accommodated in a limited space but they have a series of disadvantages. Thus, only a limited path of ca. 5 mm can be detected with such a device. If, however, it is intended to detect the position of a cylinder-piston system whose piston can be moved more than 5 mm relative to the cylinder, then other solutions must be resorted to.

Also, such a device can only be used to a limited extent in the field of motor vehicle technology. If it is intended to use such a device in the field of motor vehicle technology, then it must function reliably over a wide range of temperatures from −40° C. to 150° C. The position-detecting means from the state of the art, comprising a magnet and a Hall sensor, has, however, a significant error of measurement over the aforementioned range of temperatures. For this reason, such a position-detecting means cannot provide reliable data on which control or monitoring of the piston-cylinder system can be based in general.

Furthermore, the detection of the position of the cylinder-piston system should be robust in order to prevent possible failures of the detection of the position. If, however, the Hall sensor fails in the above-presented device from the state of the art, then detection of the position of the piston-cylinder system is no longer possible and possibly the piston-cylinder system can no longer be controlled or monitored reliably.

### SUMMARY OF THE INVENTION

A general object of the present invention is to at least partially mitigate a few of the disadvantages of the device from the state of the art.

This object is realized by a device with the features of the independent claims.

The device according to the invention for detecting the position of an hydraulic piston-cylinder system, where the hydraulic piston-cylinder system is connected to a position-detecting means which comprises a magnet and a Hall sensor, is distinguished by the fact that the connection between the hydraulic piston-cylinder system and the position-detecting means comprises a lever.

The piston as well as the cylinder of the piston-cylinder system can be connected to the lever, so that in a movement of the piston relative to the cylinder, the lever is entrained. In so doing, the lever can be connected directly to the piston-cylinder system as well as indirectly via additional components, such as, for example, a tappet rod, to the piston-cylinder system. It is sufficient for the present invention that with the change of the position of the piston-cylinder system, therefore with the change of the position of the piston relative to the cylinder, the position of the lever also changes. The lever is in turn connected directly or indirectly to at least one magnet or to at least one Hall sensor. If the piston then moves relative to the cylinder, the lever, and thus the magnet, also moves relative to the Hall sensor. The lever can then be disposed so that the distance, which the piston traverses relative to the cylinder, is greater than the change in distance between the Hall sensor and the magnet resulting therefrom. Thus, for example, the piston can engage at a point on the lever, which is further removed from the fulcrum of the lever than the point at which the magnet is connected to the lever. Through this arrangement of the lever it is possible to reliably detect the position of a cylinder-piston system whose cylinder can traverse a greater path relative to the piston, for example, more than 5 mm. It is therefore possible to be able to monitor a greater variety of cylinder-piston systems by means of Hall sensors and thus to be able to resort to this economical and space-saving alternative for position detection by means of Hall sensors in more cases than in the state of the art.

Preferably, the position-detecting means comprises at least two Hall sensors. These sensors can be disposed so that both Hall sensors can detect the magnetic field of the magnet, at least at some times. Thus, in case one of the Hall sensors is faulty, the other can continue to detect the magnetic field of the magnet and thus determine the position of the cylinder-piston system. In this way, a more robust determination of the position of the cylinder-piston system is made possible. Also, the Hall sensors can be disposed in various positions around the magnet. Due to the differences in the position, differences in the magnetic field intensity determined by the Hall sensors also result as a rule. Thus, in the case that the magnet is located between two Hall sensors and is moving towards the first Hall sensor, the level of the magnetic field at the location of the first Hall sensor increases while the level of the magnetic field at the location of the second Hall sensor decreases. By comparing the different Hall sensors the effect of the temperature on the Hall sensor signals can be then be calculated therewith and thus the position-detecting means can be used over a wide range of temperatures. In order to be able to employ such a comparison, the magnet must not be located between the two magnets [sic] but rather it should only be ruled out that both Hall sensors measure the same signal over the entire possible path. The aforementioned arrangements can be realized with two, but also with three or more, Hall sensors. Also, for reasons of precision of measurement or reliability, the position-detecting means can be equipped with several magnets.

The aforementioned lever can comprise one arm, that is, be a single-arm lever. Such a lever has a short length since the piston-cylinder system as well as the magnet engages on the same arm of the lever. Thus, such a device can be constructed in a very space-saving manner and can be integrated easily into the smallest components or small openings. Also, the distortions, which result due to the length of the lever, are as a rule small in the case of a single-arm lever so that the use of a single-arm lever minimizes the measurement errors due to the transmission of the movement.

The aforementioned lever can also comprise two arms, that is, be a two-arm lever. Such a two-arm lever permits the position-detecting means to be placed on the side of the lever, which lies on the other side of the fulcrum of the lever from the cylinder-piston system. Thus, the position-detecting means can be mounted at a distance from the cylinder-piston system and thus a sufficient space can be made available to the cylinder-piston system as well as to the position-detecting means.

Preferably, the piston-cylinder system is a part of a valve system of a hydraulics mechanism. Therein, the position of the piston in the cylinder indicates which state the valve is in. The valve can, for example, assume the state “closed” or different degrees of opening. Thus, via the determination of the position of the piston relative to the cylinder by the position-detecting means designated above, the degree of opening of the valve can be monitored. This is economical, reliable, and stable with regard to temperature.

The valve system can, in that case, be associated with an automatically controlled clutch. Such a clutch can be controlled via a hydraulic system, which in turn comprises hydraulic valves. Through the use of a lever between the valve system and the position-detecting means, greater freedom in the choice of the suitable valves can be achieved since it is also possible to use valves whose piston can traverse a large path relative to the corresponding cylinder. This path can be transmitted by the lever on the position-detecting means and in so doing converted into a smaller path. Thus, it is possible to reliably determine the position even in the case of valves, which can traverse a larger path.

The valve system is preferably associated with a twin clutch device. In that case it can also be a part of the twin clutch device. Such twin clutch devices are often controlled by hydraulic valves. Since the position-detecting means here are, on the one hand, exposed to particular variations in temperature and, on the other hand, must also function very reliably in order to ensure functioning control of the twin clutch, it is particularly preferred here to use a position-detecting means which comprises a magnet and a Hall sensor. Since, however, such valves often have a stroke which is relatively large, for example, greater than 5 mm, the use of the Hall sensor position-detecting means only becomes possible through the lever of the present invention.

The hydraulic piston-cylinder system can be an actuating element. Particularly in actuating elements it is often desirable that the actuation path can be dimensioned in different ways. Through the use of the lever to convert the actuation path into a path detectable by the position-detecting means, actuating elements with actuation paths of different sizes, in particular even those with large actuation paths, can be monitored by means of Hall sensors. This leads to a greater range of application for Hall sensor position-detecting means.

The piston-cylinder system can be a shift cylinder of a hydraulic gear shift unit. In a hydraulic gear shift unit the gears of the conventional transmission are shifted automatically or manually via a hydraulic mechanism. In so doing, the different gears are engaged with the shift cylinder; therefore the different gear transmission ratios are actuated. Also, such shift cylinders have different actuation paths, under certain circumstances dependent on the transmission system. Through the transmission of this actuation path by means of a lever to one or more position-detecting means, the position of a shift cylinder which has a large actuation path can also be determined by means of Hall sensors and thus a temperature-insensitive, small, and robust position determination can be used.

Preferably, the position of actuating elements which are a part of a continuously variable transmission, or are associated with it, can also be detected by one or more Hall sensors by the actuating element being connected by means of a lever to one or more position-detecting means.

### BRIEF DESCRIPTION OF THE DRAWINGS

The invention will be described with the aid of a schematic drawing, by way of example, and with further details, wherein:

FIG. 1 shows a schematic drawing of a device for detecting the position of a hydraulic piston-cylinder system.

### DETAILED DESCRIPTION OF THE INVENTION

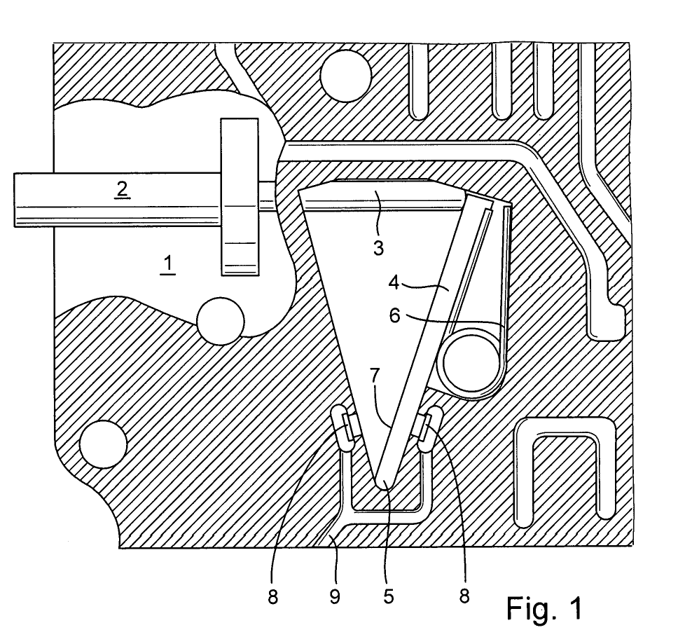

Hydraulic cylinder 1 with piston 2 is shown in FIG. 1. Piston 2 is located at least partially in cylinder 1 and the space between piston 2 and cylinder 1 indicates the position of the cylinder-piston system. Lever 4 is mounted in such a manner that it can pivot at bearing point 5 and is pressed by means of spring 6 onto tappet rod 3 which in turn presses piston 2. Thus a change in the position of piston 2 is conducted to tappet rod 3, which then moves lever 4 either with or against the force of spring 6. Between the point of engagement of tappet rod 3 on lever 4 and bearing point 5 of the lever magnet 7 is mounted on lever 4. At both sides of magnet 7 two Hall sensors 8 are disposed so as to be stationary relative to cylinder 1. These Hall sensors 8 measure the magnetic field of the magnet. Due to the different position of the Hall sensors, position detection, which is reliable even over a wide temperature range, can be ensured by the comparison of the Hall sensor signals. Hall sensors 8 are, in so doing, transmitted further to one or more controls or computers via cables, which are located in ducts 9 for the Hall sensors.

### LIST OF REFERENCE NUMBERS

1 Hydraulic cylinder
2 Piston
3 Tappet rod
4 Lever
5 Bearing point
6 Spring
7 Magnet
8 Hall sensor
9 Duct for the sensor cable

What we claim is:

1. A device for detecting the position of a hydraulic piston-cylinder system, where the hydraulic piston-cylinder system is connected to a position-detecting means which comprises a magnet and a Hall sensor, characterized by the fact that the connection between the hydraulic piston-cylinder system and the position-detecting means comprises a lever.

2. The device recited in claim 1, wherein the position-detecting means comprises at least two Hall sensors.

3. The device recited in claim 1, wherein the lever comprises one arm.

4. The device recited in claim 1, wherein the lever comprises two arms.

5. The device recited in claim 1, wherein the piston-cylinder system is part of a valve system of a hydraulic mechanism.

6. The device recited in claim 1, wherein the valve system is associated with an automatically controlled clutch.

7. The device recited in claim 5, wherein the valve system is associated with a twin clutch device.

8. The device recited in claim 1 wherein the hydraulic piston-cylinder system is an actuating element.

9. The device recited in claim 8, wherein the hydraulic piston-cylinder system is a shift cylinder of a hydraulic gear shift unit.

10. The device recited in claim 8, wherein the actuating element is associated with a continuously variable atransmission.
